(19) United States
(12) Patent Application Publication
(10) Pub. No.: US 2026/0315849 A1
(43) Pub. Date: Oct. 15, 2026

(54) AIR MAINTENANCE DEVICE FOR A DRY PIPE FIRE PROTECTION INERTING SYSTEM

(71) Applicant: Engineered Corrosion Solutions, LLC, St. Louis, MO (US)

(72) Inventors: Austin Andrews, St. Louis, MO (US); Aaron Troll, St. Charles, MO (US); Mateusz Przezdziecki, St. Louis, MO (US); Adam H. Hilton, Chesterfield, MO (US); Nicolas Sparacello, St. Charles, MO (US)

(21) Appl. No.: 19/644,856

(22) Filed: Apr. 10, 2026

Related U.S. Application Data
(60) Provisional application No. 63/787,203, filed on Apr. 11, 2025.

(51) Int. Cl. A62C 35/68; A62C 35/62

(52) U.S. Cl. CPC A62C 35/68; A62C 35/62

(57) ABSTRACT

An air maintenance device for a dry pipe inerting system in a fire protection system includes a gas inlet connected with an inert gas source; a gas outlet connected with the fire protection system; a pressure sensor to determine a current pressure within the fire protection system; a control side having a control valve between the gas inlet and the gas outlet to control a flow of gas from the gas inlet to the gas outlet; a control system connected with the control valve and the pressure sensor and configured to selectively open the control valve if a current pressure in the fire protection system is below a low pressure setpoint and close the control valve if the current pressure in the fire protection system is equal to or above a high pressure setpoint which is greater than the low pressure setpoint.

### TECHNICAL FIELD

The present disclosure relates to air maintenance devices for dry pipe fire protection inerting systems, and, more particularly, to controllable air maintenance devices for dry pipe and preaction fire protection systems.

### BACKGROUND

This section provides background information related to the present disclosure which is not necessarily prior art.

Fire protection systems include water-based systems (e.g., wet pipe fire protection systems, dry pipe fire protection systems, and preaction fire protection systems), foam-based systems, etc. The process of draining and refilling fire protection systems contributes to the formation and buildup of corrosion in the piping of wet pipe fire protection systems. This corrosion is caused, at least in part, from high oxygen content air that is introduced into the system upon refilling the system. Such corrosion can lead to system failure resulting in expensive repairs. Inerting systems for fire protection systems add an inert gas such as nitrogen to the piping network of the fire protection system in combination with a venting process to displace oxygen from the piping network.

The “fill and purge” dry pipe inerting process (referred to as “DPNI” in systems utilizing nitrogen as the inert gas), such as described in U.S. Patent Nos. 8,720,591; 9,144,700; and 9,186,533, each of which is expressly incorporated by reference herein in its entirety, for example, is a complex process that involves multiple cycles of filling and purging of the system throughout its duration. Fill and purge DPNI requires configuration of a source of inert gas and an air maintenance device (AMD) regulator such that there is a “breathing” range of 3-5 psig wherein the opening (and closing) pressure of the regulator in the AMD is 3-5 psig higher than the cut-in pressure of the inert gas source. This range ensures that the system can fully depressurize 3-5 psig and that the regulator on the AMD remains open for the entire duration of the inert gas fill portion of the cycle as the system is repressurized by 3-5 psig, back to its normal operating pressure.

If the equipment utilized for the DPNI process is not properly configured or has incorrect setpoints, equipment could be damaged or the DPNI process will be incomplete. Prior art systems utilize an AMD having a mechanical pressure regulator to maintain the desired pressure level. In some systems, the AMD may include a pressure switch that is operated based on system pressure to directly activate and/or deactivate a source of compressed gas. Industry standards applicable to AMDs include UL 260A and FM 1032, the disclosures of each of which are expressly incorporated by reference herein in its entirety. Prior art systems with AMDs incorporate mechanical gauges are prone to user error and depending on calibration can be over or under the actual system pressure by as much as 5 psig if not more. In most embodiments the system pressure is controlled by a mechanical regulator which an operator can set to a certain pressure threshold. Despite this, the regulators can still experience hysteresis which will cause a drift in their set pressure threshold depending upon the regulators inlet pressure. For example, the setpoint of a regulator set using a source of supervisory gas with an inlet pressure of 100 psig or more would drift up resulting in the fire protection system being at a higher pressure than desired during the DPNI process if the inert gas source introducing an inerting gas into the system provides a lower pressure to the regulator. This leads to unreliable results when performing the DPNI process and can cause damage to equipment due to excessive cycling or runtime on the equipment.

As recognized by the inventors of the subject application, conventional AMDs may be adversely affected by various conditions. For example, conventional AMDs having a mechanical pressure regulator may be adversely affected by the ambient temperature which may affect a setpoint of the pressure regulator, an upstream pressure which may affect the flow rate through the pressure regulator and/or a maximum pressure setting of the pressure regulator, a pressure differential which may affect the flow rate through the pressure regulator, and corrosion and/or other debris which may affect the functionality of the pressure regulator and/or a backflow prevention device. Additionally, the pressure regulator of conventional AMDs may experience device fatigue causing possible pressure setting failure due to multiple cycles of use. Also, pressure settings in the pressure regulator of conventional AMDs may be difficult to reproduce. Further, when multiple fire protection systems are employed and connected to a single source of supervisory gas, accuracy and precision of their pressure regulator may be affected when coordinating pressure settings between the systems including, for example, when the pressure settings are designed for dry pipe systems or preaction systems.

Some systems have explored the usage of a receiver tank located between the source of gas and the AMD to assist with maintaining a stable pressure in the fire protection system as well as mitigate the impact of small leaks on the inlet of the AMD. With currently available mechanical air maintenance devices, the addition of the reservoir lengthens the amount of time it takes to purge the dry pipe or pre-action fire protection system.

All fire protection systems connected to the inert gas source used for the fill and purge DPNI process must operate at approximately the same pressure. Otherwise, depending on at what cut-in pressure the inert gas supply equipment is set to, systems at lower pressures may short-cycle the inert gas supply equipment or systems at higher pressures may cause excessive runtimes of the inert gas generation equipment. If the cut-in pressure of the supply equipment is too low, systems operating at higher pressures may even trip, leading to water flowing and building alarms being activated.

These elements make accurately configuring the equipment for the fill and purge DPNI process extremely challenging and time-consuming. These challenges if not resolved properly and efficiently can lead to incorrect configuration of the DPNI system and result in damage to the DPNI equipment as well as impairing the DPNI process (due to incomplete fill-and-purge cycles, either because the cycles weren’t “large” enough, or because the “breathing” range was too large, and the process could not complete enough cycles in the allotted time frame). Therefore, it would be beneficial to have an alternative system and method for an air maintenance device that supports DPNI of a fire protection system.

### SUMMARY

The needs set forth herein as well as further and other needs and advantages are addressed by the present embodiments, which illustrate solutions and advantages described below.

Embodiments according to the present teachings include, but are not limited to, an air maintenance device for a dry pipe inerting system in a fire protection system that includes a gas inlet in fluid communication with an inert gas source; a gas outlet in fluid communication with the fire protection system; at least one pressure sensor configured to determine a current pressure within the fire protection system; a control side containing a control valve in fluid communication with and between the gas inlet and the gas outlet, the control valve operable to control a flow of gas from the gas inlet to the gas outlet, the control valve being an electrically or pneumatically controlled valve; a control system in electrical communication with the control valve and the pressure sensor, wherein the control system is configured to selectively open the control valve if a current pressure in the fire protection system is below a low pressure setpoint and close the control valve if the current pressure in the fire protection system is equal to or above a high pressure setpoint which is greater than the low pressure setpoint. In another embodiment the high pressure setpoint and low pressure setpoint are set and adjusted by a user. In other embodiments, an algorithm or other non-manual, software or electronic method may be implemented to adjust the high and low pressure setpoints based on measured system parameters or other relevant parameters.

Some embodiments disclose a control system containing at least a processor module; a power module configured to supply power for the control system; a communications module in communication with the processor module and configured to receive data at least from the at least one pressure sensor, transmit the received data to the processor module, and relay operational signals from the processor module to the control valve; a memory module in communication with the processor module and configured to store the high pressure setpoint and the low pressure setpoint; and a user interface in communication with the communications module and configured to display operational information of the air maintenance device to a user and to allow the user to input or adjust one or more operational parameters for the air maintenance device, the one or more operational parameters comprising the low pressure setpoint and the high pressure setpoint. The memory module may be further configured to store current and/or historical operating data, user settings, and other system operation information. In another embodiment, a flow transmitter in communication with the control system is provided to detect the flow of gas to the fire protection system from the air maintenance device and transmit a flow signal to the control system.

According to another aspect of the present disclosure, the flow transmitter is configured to determine a current flow rate of the flow of gas to the fire protection system and the control system is configured to compare the current flow rate to a base flow rate and generate a notification or alert if the current flow rate is outside of a set flow rate parameter. The control system may be similarly configured to compare values from any of the other sensors of the system and generate a notification when the current value measured by the relevant sensor is outside of a set parameter. In some embodiments, the control system may be configured to initiate mitigating action based on the value transmitted from the flow transmitter or other sensors, for example, opening and/or closing one or more valves in the AMD or temporarily increasing pressure to the AMD to clear a blockage.

According to another aspect of the present disclosure, the AMD includes a bypass side having a bypass valve and configured to direct the flow of gas around the control side by manually or electronically opening the bypass valve.

In another embodiment, a valve is included on the inlet and outlets of the AMD. Some embodiments include a gas purity sensor in communication with the control system and configured to monitor the purity or concentration of gas in the fire protection system and transmit a gas purity signal to the control system. In some embodiments, the gas purity signal may be transmitted to other external devices either alternately or in addition to the control system.

According to another aspect of the present disclosure relating to systems in which an inert gas generator may not be used, the control system is configured to adjust the high pressure setpoint and the low pressure setpoint closer together to behave more like a standard air maintenance device. In other embodiments, the control system is configured to adjust the setpoints automatically upon completion of the dry pipe inerting process.

In other embodiments, the fire protection system includes at least one additional operational sensor in communication with the control system.

According to another aspect of the present disclosure, there is provided an air maintenance device for a fill and purge inerting system in a dry pipe fire protection system that includes a gas inlet in fluid communication with an inert gas source; a gas outlet in fluid communication with the dry pipe fire protection system; at least one pressure sensor configured to determine a current pressure within the dry pipe fire protection system; a control side containing a control valve in fluid communication with and between the gas inlet and the gas outlet, the control valve operable to control a flow of gas from the gas inlet to the gas outlet, the control valve being an electrically controlled valve; a control system in electrical communication with the control valve and the pressure sensor, wherein the control system is configured to selectively open the control valve if the current pressure in the dry pipe fire protection system is below an opening pressure setpoint and close the control valve if the current pressure in the dry pipe fire protection system is equal to or above a closing pressure setpoint.

A fill and purge inerting process in a dry pipe fire protection system includes the steps of providing an air maintenance device in the dry pipe fire protection system having a gas inlet in fluid communication with an inert gas source; a gas outlet in fluid communication with the fire protection system; at least one pressure sensor configured to determine a current pressure within the dry pipe fire protection system; a control side containing a control valve in fluid communication with and between the gas inlet and the gas outlet, the control valve operable to control a flow of gas from the gas inlet to the gas outlet, the control valve being an electrically controlled valve; a control system in electrical communication with the control valve and the pressure sensor and configured to receive a current pressure signal from the control valve and transmit a control signal to the control valve; transmitting the current pressure signal from the at least one pressure sensor to the control system; determining in the control system if the current pressure in the dry pipe fire protection system is below an opening pressure setpoint or equal to or above a closing pressure setpoint for the fill and purge inerting process; and transmitting the control valve signal from the control system to the control valve; and selectively opening the control valve if the current pressure in the fire protection system is below the opening pressure setpoint and closing the control valve if the current pressure in the fire protection system is equal to or above the closing pressure setpoint.

These aspects are merely illustrative of the innumerable aspects associated with the present disclosure and should not be deemed as limiting in any manner. These and other aspects, features and advantages of the present disclosure will become apparent from the following detailed description when taken in conjunction with the referenced drawings.

### BRIEF DESCRIPTION OF THE DRAWINGS

FIG. 1 is a schematic diagram of an air maintenance device used to perform a dry pipe inerting process on a fire protection system according to the present teachings.

FIG. 2 is a schematic diagram of an embodiment of an air maintenance device used to perform a DPNI process on a fire protection system according to the present teachings.

FIG. 3 is a schematic diagram of an embodiment of an air maintenance device containing a flow transmitter which is used to perform a dry pipe inerting process on a fire protection system according to the present teachings.

FIG. 4 is a schematic diagram of an embodiment of an air maintenance device containing a gas purity sensor which is used to perform a dry pipe inerting process on a fire protection system according to the present teachings.

FIG. 5 is a schematic diagram of an embodiment of the control system for an air maintenance device used to perform a dry pipe inerting process on a fire protection system according to the present teachings.

### DETAILED DESCRIPTION

The present teachings are described more fully hereinafter with reference to the accompanying drawings, in which the present embodiments are shown. The following description is presented for illustrative purposes only and the present teachings should not be limited to these embodiments.

Generally, all terms used in the claims are to be interpreted according to their ordinary meaning in the technical field, unless explicitly defined otherwise herein. All references to a/an/the element, apparatus, component, means, step, etc., are to be interpreted openly as referring to at least one instance of the element, apparatus, component, step, etc., unless explicitly stated otherwise. The steps of any method disclosed herein do not have to be performed in the exact order disclosed, unless explicitly stated. The use of “first,” “second,” etc., for different features/components of the present disclosure are only intended to distinguish the features/components from other similar features/components and not to impart any order or hierarchy to the features/components.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles, or systems described herein may be used in several directions and orientations.

In accordance with the present teachings an AMD is designed to control and monitor the fill and purge elements of the dry pipe inerting process. The AMD can be retrofitted onto existing fire protection systems and in some embodiments will replace existing AMD systems. In other embodiments the disclosed AMD system may be added to a system with a pre-existing AMD. In accordance with one embodiment of the present teachings the AMD will function by using two pressure setpoints. The AMD will have a high pressure setpoint and a low pressure setpoint. The execution of the fill and purge sequences of the dry pipe inerting process requires the system to be configured with some range between the high and low pressure setpoints of the AMD. The opening, cut-in, or low pressure setpoint must be lower than the closing, high, or cut-out pressure setpoint. This allows the AMD to pressurize the fire protection system past the cut-in pressure setpoint, creating the conditions needed for the fire protection system to be vented back down to the cut in pressure where it can then be repressurized back to the higher cut-out pressure. In accordance with the present teachings the AMD utilizes a control system to maintain direct control over both the low and high pressure setpoints.

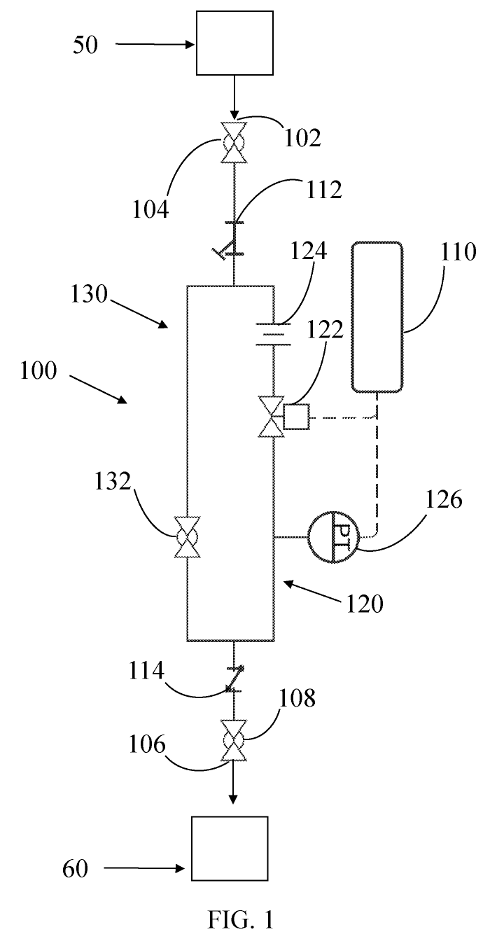

FIG. 1 illustrates a schematic of an AMD 100 used to perform a dry pipe inerting process on a fire protection system 60 according to the present disclosure. The illustrated embodiment of the AMD 100 has an inlet 102 which is in fluid communication with an inert gas source 50. The inert gas source 50 may be, but is not limited to, an inert gas generator or storage device that is configured to supply inert gas, for example, nitrogen. In the illustrated embodiment an inlet valve 104 is shown directly at the inlet 102. The inlet valve 104 may be manual, pneumatic, or electronic and can be used to seal off the AMD 100 or allow gas to pass through. In some embodiments the inlet valve 104 may be located further downstream from the inlet 102. In other embodiments, the inlet valve 104 may be located within the inert gas source 50. An outlet 106 is depicted in the illustrated embodiment of FIG. 1. The outlet 106 is in fluid communication with the fire protection system 60 and provides inert gas to the fire protection system 60. In some embodiments an outlet valve 108 is included in the system. The outlet valve 108 may be, but is not limited to, a manual, pneumatic, or electronic valve. In some embodiments the outlet valve 108 is located in the fire protection system 60. In the illustrated embodiment of the AMD 100, both the inlet valve 104 and the outlet valve 108 must be open for flow to pass through the AMD 100. These valves may be opened and closed by an operator in some embodiments. In other embodiments these valves can be actuated by a control system 110. Some embodiments have multiple manual valves placed throughout the AMD 100 to allow for certain areas to be blocked off during maintenance or system isolation. In some embodiments, a strainer 112 is located downstream of the inlet 102 to protect the AMD 100 from debris or other impurities. In the illustrated embodiment, a y-strainer 112 is depicted. In other embodiments a cylindrical filter may be used or other components capable of removing debris from incoming gas flow.

In the illustrated embodiment of FIG. 1, the AMD 100 is provided with a control side 120 and a bypass side 130. Some embodiments may only have a control side 120 and forgo the bypass side 130. The strainer 112 is located prior to control side 120.

In some embodiments, the control side 120 includes a control valve 122, a restricted orifice 124, and at least one pressure transducer 126. In other embodiments, the control side 120 may also include a regulator (not shown) as a mechanical failsafe or to reduce pressure supplied to the components on the control side 120 to protect from damage. In some embodiments, mechanical gauges are placed throughout the system to provide a fail-safe in case of loss of power or electronic failure.

The control valve 122 in the illustrated embodiment is an electronic valve and is controlled via the control system 110. The control valve 122 may include, but is not limited to, a normally open solenoid, a normally closed solenoid, electronically actuated ball valve, electronically actuated gate valve, stepper valve, or other valves configured to selectively open and close to prevent and allow a flow of gas or other fluid within a pipe or conduit. The control system 110 may be in wired or wireless communication with the control valve 122. The wireless connection may consist of, but is not limited to, at least one or a combination of Bluetooth, Bluetooth Low Energy, Wi-Fi, Cellular 3G/4G/5G, or Low-Power Wide Area Networking. The control system 110 is configured to open or close the control valve 122 based upon the high and low pressure setpoints. In some embodiments, the high and low pressure setpoints are user adjustable. In some embodiments, the control system 110 may include an algorithm or other non-manual, software or electronic method configured to adjust the high and low pressure setpoints based on measured system parameters or other relevant parameters.

The pressure transducer 126 is configured to monitor pressure in the system for comparison with the high and low pressure setpoints. In the illustrated embodiment, the pressure transducer 126 may be located within the control side 120 between the control valve 122 and the outlet 106. However, the pressure transducer 120 may alternatively be located outside of the control side 120 in any suitable position of the fire protection system. In some embodiments, the pressure transducer 126 may be located between the control valve 122 and outlet 106 but not within the control side 120 of the AMD 100, for example, between . In some embodiments, the pressure transducer 126, or a second pressure transducer, may be located in the fire protection system remotely from the AMD 100 and have a wired or wireless connection with the control system 110. In other embodiments, the pressure transducer 126 may consist of any sensor able to measure a current pressure within the AMD 100. In some embodiments, an additional pressure sensor may be located between the control valve 122 and the inlet 102 to provide measurements on the pressure of gas from the inert gas source 50.

A restricted orifice 124 may be included on the control side 120. The restricted orifice 124 is configured to control the maximum flow rate through the control side 120. In some embodiments, the restricted orifice 124 is adjustable. In other embodiments where the flow is restricted through other means or the restriction is not necessary, the restricted orifice 124 may not be included.

In some embodiments, a check valve 114 is located in the AMD 100 between the control valve 122 and/or bypass valve 132 and the outlet 106. The check valve 114 prevents ingress of water, gas or other fluids from the fire protection system 60 from entering into the AMD 100. In some embodiments, the check valve 114 may be, but is not limited to, a swing, spring, piston, or other type of reverse flow control valve.

The low pressure setpoint of the control system 110 is the threshold that is used to determine when gas may be permitted to flow into the fire protection system 60. The low pressure setpoint, which may be adjustable in some embodiments, may be as low as 5 psig in some embodiments and as high as 70 psig in other embodiments. In some embodiments the low pressure setpoint may be between 10 to 35 psig. During operation of the AMD 100, the control valve 122 is opened to allow inert gas from the inert gas source 50 to flow through the control side 120 and into the fire protection systems 60 when the pressure read by the pressure transducer 126 falls to or below the low pressure setpoint. The fire protection system 60 is then pressurized until the high pressure setpoint is reached. The specific setpoint pressure values referenced above and elsewhere in the present disclosure are non-limiting examples from various potential implementations of embodiments of the present disclosure.

The high pressure setpoint is the threshold at which the control system 110 closes the control valve 122 to stop gas flow into the fire protection system 60. In some embodiments, the high pressure setpoint is as low as 10 psig, and in others the setpoint is around 75 psig. In some embodiments the high pressure setpoint may be between 12 to 40 psig. Once the high pressure setpoint is reached, the control system 110 closes the control valve 122 and the pressure within the fire protection system 60 is allowed to decay or vent until the pressure in the fire protection system 60 falls below the low pressure setpoint. In some embodiments, a vent (not shown) is provided in the fire protection system 60 that may be electronically controlled by the control system 110.

The AMD 100 may have a bypass side 130 in addition to the control side 120. The bypass side 130 allows for gas to flow from the inert gas source 50 to the fire protection system 60 without passing through the control side 120 of the AMD 100. In some embodiments, the bypass side 130 has a bypass valve 132, which can be opened to allow flow through the bypass side 130. The bypass valve 132 may be manual or in some embodiments the bypass valve 132 may be controlled by the control system 110. The bypass side 130 allows for faster pressurization of the fire protection system 60. Once pressure is built up in the fire protection system 60 to a desired level, the bypass valve 132 can be closed to direct the flow of gas from the inert gas source 50 through the control side 120 again.

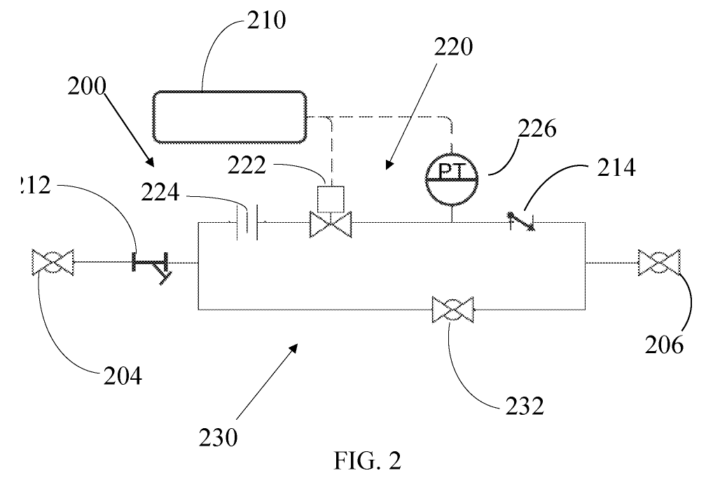

Another embodiment of the AMD 200 with a different placement of the check valve 214 is described with reference to FIG. 2. In the illustrated embodiment, the AMD 200 is similar to the AMD 100 described above in reference to the illustrated embodiment of FIG. 1 described above. Therefore, the description of the AMD 200 will generally discuss the main differences. A check valve 214 is utilized to prevent ingress of water into the AMD 200 or gas source 50. In some embodiments as illustrated in FIG. 1 the check valve 114 may be placed between an outlet 106 and both the control 122 and bypass 132 valves. In the illustrated embodiment of FIG. 2 the check valve 214 is located between the control valve 222 and the outlet 206.

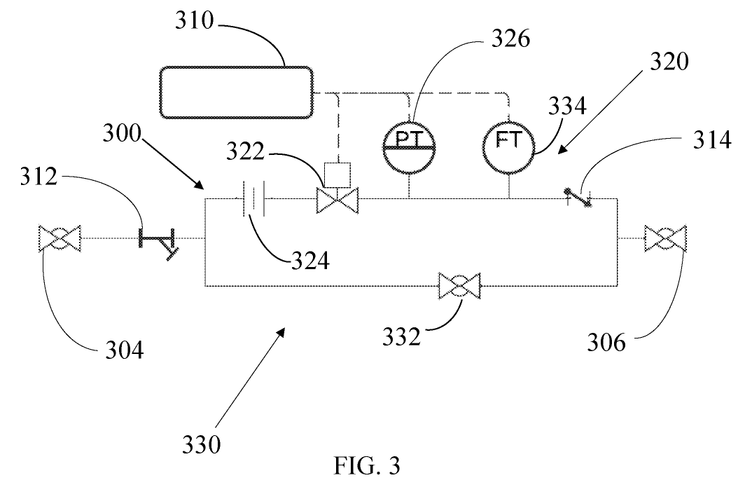

Another embodiment of the AMD 300 with a flow transmitter 334 is described with reference to FIG. 3. The AMD 300 of FIG. 3 is similar to the AMD 200 in the illustrated embodiment of FIG. 2 described above. Therefore, the description of the AMD 300 will generally discuss the main differences. In the illustrated embodiment of FIG. 3, a flow transmitter 334 is provided on the control side 320 of the AMD 300. In other embodiments, the flow transmitter 334 may be located downstream of both the control valve 322 and the bypass valve 332, or upstream of the control valve 322 or the bypass valve 332 or upstream of both. In some embodiments, the flow transmitter 334 may be a switch or a flow meter configured to transmit a signal to the control system 310 indicating whether gas is flowing through the AMD 300. In some embodiments, the flow transmitter 334 is configured to measure a current flow rate of gas passing through the AMD 300. Some embodiments of the control system 310 may be configured to use the current flow rate to monitor the health of the AMD 300 and gas source 50. In other embodiments, the control system 310 may be configured to compare the current flow rate to a base flow rate and produce a notification or an alert, for example, an audible and/or visible alarm or automated message relayed to a control panel or to a user’s computer, cell phone or other mobile device, of any flow abnormalities or deviations from a set of parameters. The control system may be similarly configured to compare values from any of the other sensors of the fire protection system and generate a notification when the current value measured by the relevant sensor is outside of a set parameter. In some embodiments, the control system 310 may be configured to initiate mitigating action based on the value transmitted from the flow transmitter 334 or other sensors, for example, opening and/or closing one or more valves in the AMD or temporarily increasing pressure to the AMD to clear a blockage.

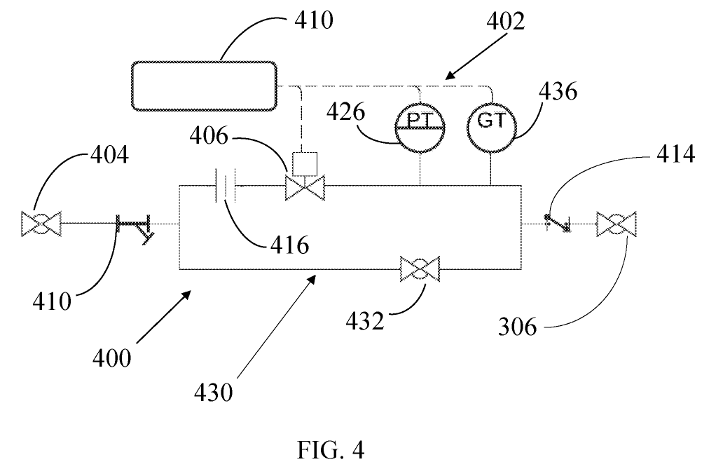

Another embodiment of the AMD 400 with a gas purity sensor 436 is described with reference to FIG. 4. The AMD 400 is similar to the AMD 100 utilized within the illustrated embodiment of FIG. 1 described above. Therefore, the description of the AMD 400 will generally discuss the main differences. In the illustrated embodiment of FIG. 4, a gas purity sensor 436 is provided on the control side 420 of the AMD 400. The gas purity sensor 436 may be an oxygen purity sensor or an inert gas purity sensor, and may include, but is not limited to, an optical, zirconium, paramagnetic, chemical, humidity or other sensor types suitable for use in gas monitoring applications. The gas purity sensor 436 may be configured to monitor the purity or relative concentration of oxygen or inert gas of gas flowing into the fire protection system 60. In some embodiments, purity or concentration measurements taken by the gas purity sensor 436 are transmitted to and stored in the control system 410.

In another embodiment, the control system 410 is configured to use the measured concentration to monitor the health of the inert gas source 50. In other embodiments, the control system 410 may be configured to compare the measured concentration received from the gas purity sensor 436 with a base value or target value and produce an alert, for example, an audible and/or visible alarm or automated message relayed to a control panel or to a user’s computer, cell phone or other mobile device, of any concentration or purity abnormalities or deviations from a set of parameters. In another embodiment, the control system 410 is configured to determine if the dry pipe inerting process is complete based on the purity or concentration measurements received from the gas purity sensor 436.

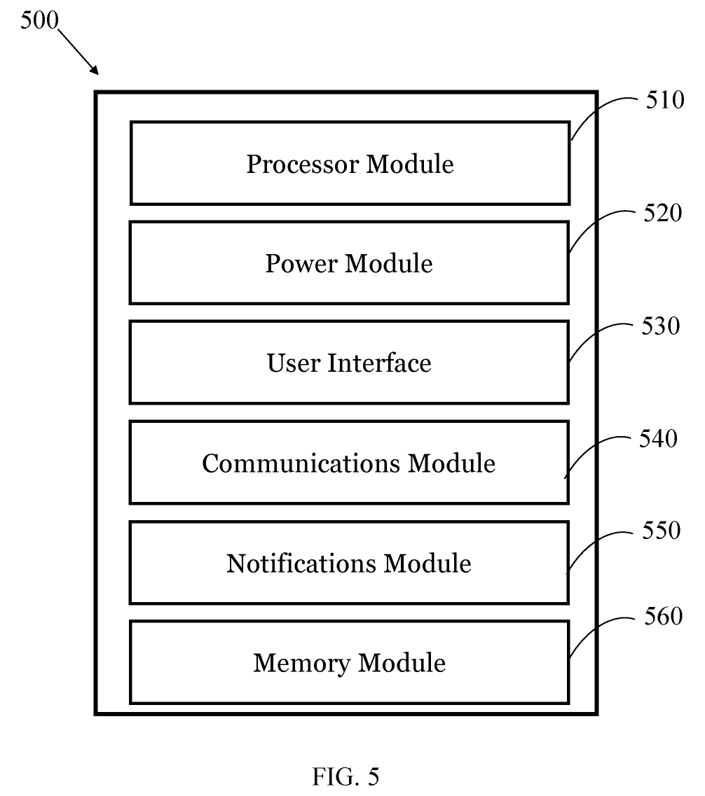

FIG. 5 provides a component schematic for an embodiment of a control system 500 for an air maintenance device used to perform a dry pipe inerting process on a fire protection system. The control system 500 of the embodiment of FIG. 5 may include at least one processor module 510, a power module 520, a user interface 530, a communications module 540, a notification module 550, and a memory module 560. Some embodiments may have each of these components while others may only have some of the components depending on the requirements of the system and its environment. In some embodiments, all of these components are contained within a single enclosure. In other embodiments, one or more of the components may be distributed at different locations throughout the AMD system, at other points within the fire protection system, or even remotely from the AMD and fire protection system. In some embodiments, the processor module of the control system 110 or 500 may comprise or incorporate a programmable logic controller (PLC) or some form of firmware, for example, a printed circuit board(s), plug-in component, or a USB drive or other connected flash drive or solid state drive (SSD).

The communications module 540 may be wired to the other components of the control system 500 and with sensors and valves throughout the fire protection system or utilize wireless communication to transmit and receive signals to and from the other components of the control system 500 and with the sensors and valves of the fire protection system to allow control and monitoring of the system and communication with users. In some embodiments, the communications module 540 is connected to sensors in the AMD and the fire protection system. In some embodiments, the processor module 510 accumulates data received from the communications module 540 and analyzes sensor data to determine if the AMD is operating within set parameters.

The user interface 530 allows a user to control the AMD, for example, to adjust system parameters and operating settings. The processor module 510 may also review contact points based on system alarms, such as relay contacts, serial connections, ethernet connections, analog outputs, or a combination thereof. In some embodiments, the processor 510 may be configured to use its own output contacts to control external devices within the system. In another embodiment, the data points received by the communications module 540 may be stored in the memory module 560 and accessed by the processor module 510 to determine a current operating state of the system. In other embodiments, desired operating parameters may be preset into the processor module 510 and are not adjustable. Command signals can be sent to valves within the system to actuate them in response to current conditions in the AMD and the fire protection system.

In some embodiments depending on the particular type of dry pipe inerting process involved, if the processor module 510 concludes that the dry pipe inerting process has been completed based on analysis of sensor data, the processor module 510 may be configured to automatically adjust the high and low pressure setpoints of the AMD based on whether the received sensor data indicates that the dry pipe inerting process has been properly and fully completed. For example, it may be advantageous to narrow the high and low pressure setpoints so that they only differ by 1 psig or even less. For example, these embodiments may be utilized for systems in which standard compressed air is the supply gas rather than an inert gas, such as nitrogen, when using cylinders instead of an inert gas generator, or when using a dry pipe inerting process that is a constant pressure purge rather than a fill and purge breathing process.

In other embodiments, the processor module 510 may be configured to communicate and exchange data via the communications module 540 with external devices like vent controllers, external purity sensors, or inert gas generators to determine that the dry pipe inerting process has been completed. In these embodiments the control system 500 may send a signal via the communications module 540 to these device(s) to indicate the completion of the process and trigger steps to end the dry pipe inerting process and return the device(s) to a standard operating mode.

In some embodiments, an audible or visual alarm may be triggered and/or a notification may be transmitted to a remote device or server via the notifications module 550 and/or communications module 540 if the control system 500 determines that the system is operating outside of the set operating parameters. The remote device may include, but is not limited to, a server, a cloud-based computing program, a remote PC, a mobile device, or a combination thereof. In some embodiments, the remote device may access data stored in the memory module 560 and/or control operation of the various modules of the control system 500 through the communications module 540. In some embodiments, the power module 520 is internal to the control system 500. In some embodiments, the power module 520 may include a backup battery. In other embodiments, the power module is located outside of the control system 500. Some embodiments may include a single control system 500 for each AMD. In other embodiments, a single control system 500 may be connected with multiple fire protection systems to monitor and control the dry pipe inerting process for all the connected fire protection systems.

Embodiments of the present disclosure allow for operation of the system independently of the pressure of the supervisory gas source because both the opening and closing pressure setpoints are controlled at the AMD such that the opening pressure setpoint is no longer tied to the supervisory gas source pressure. This feature of the present disclosure also allows multiple fire protection systems connected with a single supervisory gas source to be independently operated at different system pressures, whereas prior art systems required each of the fire protection systems to be operated at the same pressure. Further, embodiments of the present disclosure facilitate use of a receiver tank between an inert gas source and the AMD without impairing the pressure cycling of the fill and purge process by effectively buffering the total volume of gas available in the system supply line.

While the embodiments described herein refer to control of a fire protection system inerting process with an AMD by means of high and lower pressure setpoints, embodiments of the present disclosure may employ alternate methods to adjust operation of an AMD, either in conjunction with or in lieu of pressure setpoints. For example, embodiments may close the inlet valve and/or outlet valve of the AMD to prevent additional gas from entering the fire protection system if a rapid and/or significant reduction in pressure is detected to decrease the fire protection system trip time, for example, in a fire event. Other embodiments may dynamically adjust the pressure setpoints and/or the pressure differential between the high pressure and low pressure setpoints based on the current stage of the dry pipe inerting process. For example, a larger pressure setpoint differential may be used during initial stages of the inerting process and a smaller pressure setpoint differential may be used during later stages of the inerting process. In other embodiments, the pressure setpoint differential may be reduced to a nominal value to maintain a desired system pressure. In some embodiments, the AMD may be configured to detect and monitor when the inert gas generator is operating and to optimize the AMD’s opening and closing cycling to make operation of the generator more efficient, for example, by reducing short-cycling and extended runtimes of the generator to reduce wear on the generator and extend the effective lifespan of the generator.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

What is claimed is:

1. An air maintenance device for a dry pipe inerting system in a dry pipe fire protection system having an inert gas source, comprising:
a gas inlet in fluid communication with the inert gas source;
a gas outlet in fluid communication with the dry pipe fire protection system;
at least one pressure sensor configured to determine a current pressure within the dry pipe fire protection system;
a control side comprising:
a control valve in fluid communication with and between the gas inlet and the gas outlet, the control valve operable to control a flow of gas from the gas inlet to the gas outlet, the control valve being an electrically controlled valve;
a control system in electrical communication with the control valve and the pressure sensor; and
wherein the control system is configured to selectively open the control valve if the current pressure in the dry pipe fire protection system is below a low pressure setpoint and close the control valve if the current pressure in the dry pipe fire protection system is equal to or above a high pressure setpoint which is greater than the low pressure setpoint.

2. The air maintenance device of claim 1, wherein the low pressure setpoint represents an opening pressure setpoint for a fill and purge dry pipe inerting process and wherein the high pressure setpoint represents a closing pressure setpoint for the fill and purge dry pipe inerting process.

3. The air maintenance device of claim 1, wherein the high pressure setpoint and the low pressure setpoint are adjustable.

4. The air maintenance device of claim 1, wherein the control system further comprises:
a processor module;
a power module configured to supply power for the control system;
a communications module in communication with the processor module and configured to receive data at least from the at least one pressure sensor, transmit the received data to the processor module, and relay operational signals from the processor module to the control valve;
a memory module in communication with the processor module and configured to store the high pressure setpoint and the low pressure setpoint; and
a user interface in communication with the communications module and configured to display operational information of the air maintenance device to a user and to allow the user to input or adjust one or more operational parameters for the air maintenance device, the one or more operational parameters comprising the low pressure setpoint and the high pressure setpoint.

5. The air maintenance device of claim 1, further comprising a flow transmitter in communication with the control system and configured to detect the flow of gas to the dry pipe fire protection system from the air maintenance device and transmit a flow signal to the control system.

6. The air maintenance device of claim 5, wherein the flow transmitter is further configured to determine a current flow rate of the flow of gas to the dry pipe fire protection system and the control system is further configured to compare the current flow rate to a set flow rate range and generate a notification if the current flow rate is outside of the set flow rate range.

7. The air maintenance device of claim 5, further comprising:
an inlet valve in fluid communication with the inert gas source and configured to control the flow of gas from the inert gas source to the air maintenance device;
an outlet valve in fluid communication with the dry pipe fire protection system and configured to control the flow of gas from the air maintenance device to the dry pipe fire protection system;
wherein the flow transmitter is further configured to determine a current flow rate of the flow of gas to the dry pipe fire protection system; and
wherein the control system is further configured to selectively and independently open and close each of the control valve, the inlet valve, and the outlet valve if the current flow rate indicates a blockage in the air maintenance device.

8. The air maintenance device of claim 1, further comprising:
an inlet valve in fluid communication with the inert gas source and configured to control the flow of gas from the inert gas source to the air maintenance device;
an outlet valve in fluid communication with the dry pipe fire protection system and configured to control the flow of gas from the air maintenance device to the dry pipe fire protection system; and
wherein the control system is further configured to selectively and independently open and close each of the inlet valve and the outlet valve if the pressure transducer detects a rapid or significant decrease of pressure in the fire protection system.

9. The air maintenance device of claim 1, wherein the control system is further configured to dynamically adjust at least one of the high pressure setpoint, the low pressure setpoint, and a pressure setpoint differential based on a current stage of a dry pipe inerting process being performed by the dry pipe inerting system.

10. The air maintenance device of claim 1, wherein the control system is further configured to adjust at least one of the high pressure setpoint and the low pressure setpoint to reduce a pressure setpoint differential to a nominal value to maintain a desired system pressure in the fire protection system.

11. The air maintenance device of claim 1, further comprising a bypass side having bypass valve and configured to direct the flow of gas around the control side by opening the bypass valve.

12. The air maintenance device of claim 1, further comprising:
an inlet valve in fluid communication with the inert gas source and configured to control the flow of gas from the inert gas source to the air maintenance device; and
an outlet valve in fluid communication with the dry pipe fire protection system and configured to control the flow of gas from the air maintenance device to the dry pipe fire protection system.

13. The air maintenance device of claim 12, wherein the control system is further configured to selectively open and close the inlet valve and the outlet valve.

14. The air maintenance device of claim 1, further comprising a gas purity sensor in communication with the control system and configured to monitor the purity or concentration of gas in the dry pipe fire protection system and transmit a gas purity signal to the control system.

15. The air maintenance device of claim 1, wherein the control system is configured to adjust the high pressure setpoint and the low pressure setpoint to reduce a difference between the high pressure setpoint and low pressure setpoint upon completion of a dry pipe inerting process.

16. The air maintenance device of claim 1, wherein the dry pipe fire protection system includes at least one additional operational sensor in communication with the control system and configured to transmit an operational sensor signal as a function of a current operational parameter value to the control system.

17. The air maintenance device of claim 16, wherein the control system is further configured to compare the current operational parameter value with a set operational parameter value range and generate a notification if the current operational parameter value is outside of the set operational parameter value range.

18. An air maintenance device for a fill and purge inerting system in a dry pipe fire protection system having an inert gas source, comprising:
a gas inlet in fluid communication with an inert gas source;
a gas outlet in fluid communication with the dry pipe fire protection system;
at least one pressure sensor configured to determine a current pressure within the dry pipe fire protection system;
a control side comprising:
at least one pressure sensor configured to determine a current pressure within the dry pipe fire protection system;
a control valve in fluid communication with and between the gas inlet and the gas outlet, the control valve operable to control a flow of gas from the gas inlet to the gas outlet, the control valve being an electrically controlled valve;
a control system in electrical communication with the control valve and the pressure sensor; and
wherein the control system is configured to selectively open the control valve if the current pressure in the dry pipe fire protection system is below an opening pressure setpoint and close the control valve if the current pressure in the dry pipe fire protection system is equal to or above a closing pressure setpoint.

19. A fill and purge inerting process for a dry pipe inerting system in a dry pipe fire protection system having an inert gas source, comprising the steps of:
providing an air maintenance device in the dry pipe inerting system comprising:
a gas inlet in fluid communication with the inert gas source;
a gas outlet in fluid communication with the dry pipe fire protection system;
at least one pressure sensor configured to determine a current pressure within the dry pipe fire protection system;
a control side comprising:
a control valve in fluid communication with and between the gas inlet and the gas outlet, the control valve operable to control a flow of gas from the gas inlet to the gas outlet, the control valve being an electrically controlled valve; and
a control system in electrical communication with the control valve and the pressure sensor and configured to receive a current pressure signal from the control valve and transmit a control signal to the control valve;
transmitting the current pressure signal from the at least one pressure sensor to the control system;
determining in the control system if the current pressure in the dry pipe fire protection system is below an opening pressure setpoint or equal to or above a closing pressure setpoint for the fill and purge inerting process;
transmitting the control valve signal from the control system to the control valve; and
selectively opening the control valve if the current pressure in the fire protection system is below the opening pressure setpoint and closing the control valve if the current pressure in the fire protection system is equal to or above the closing pressure setpoint.
